(19) United States
(12) Patent Application Publication
(10) Pub. No.: US 2026/0089442 A1
(43) Pub. Date: Mar. 26, 2026

(54) AUDIO SIGNAL PROCESSING METHOD AND AUDIO SIGNAL PROCESSING APPARATUS

(71) Applicant: Tymphany HK Limited, Hong Kong (HK)

(72) Inventor: Ryan Meng-Wei LU, Taipei City (TW)

(21) Appl. No.: 19/049,221

(22) Filed: Feb. 10, 2025

(30) Foreign Application Priority Data
Sep. 23, 2024 (CN) 202422320448.3

(51) Int. Cl. H04R 3/04; H04R 29/00

(52) U.S. Cl. CPC H04R 3/04; H04R 29/001; H04R 2430/01

(57) ABSTRACT

An audio signal processing method includes obtaining an audio signal and a detected signal; obtaining a frequency range, wherein the frequency range includes an upper limit frequency and a lower limit frequency; calculating a first sound pressure difference between the audio signal filtered at the upper limit frequency and the audio signal filtered at the lower limit frequency; calculating a second sound pressure difference between the detected signal filtered at the upper limit frequency and the detected signal filtered at the lower limit frequency; generating a compensation value according to the first sound pressure difference and the second sound pressure difference; and adjusting the audio signal according to the compensation value. Based on the first sound pressure difference corresponding to the audio signal and the second sound pressure difference corresponding to the detected signal, the compensation value is generated to compensate the audio signal to prevent sound attenuation and gain.

### CROSS-REFERENCE TO RELATED APPLICATIONS

This application claims priority of China Utility Model Application No. CN202422320448.3 filed on Sep. 23, 2024 under 35 USC. § 119(e), the entire contents of which are hereby incorporated by reference.

### TECHNICAL FIELD

The present invention relates to sound processing, and in particular, to an audio signal processing method and an audio signal processing apparatus for preventing sound attenuation and gain.

### BACKGROUND OF THE INVENTION

Currently, the rapid development of technology is improving the quality of daily life, the user's demand for sound quality is growing, the quality of audio devices is increasing accordingly, and common audio devices are headphones. Wireless earbud headphones (earbuds) are popular among users because of their portability, but the shape of the earbuds is not suitable for the shape of all users'ears, and the environment in which the earbuds are used may result in sound attenuation and gain which diminish the sound quality of the earbuds.

### SUMMARY OF THE INVENTION

In accordance with the foregoing, the present invention provides an audio signal processing method and an audio signal processing apparatus for solving the problem of sound attenuation and gain.

According to the foregoing object, the present invention provides an audio signal processing method comprising: obtaining an audio signal and a detected signal; obtaining a frequency range, wherein the frequency range includes an upper limit frequency and a lower limit frequency; calculating a first sound pressure difference between the audio signal filtered at the upper limit frequency and the audio signal filtered at the lower limit frequency; calculating a second sound pressure difference between the detected signal filtered at the upper limit frequency and the detected signal filtered at the lower limit frequency; generating a compensation value according to the first sound pressure difference and the second sound pressure difference; and adjusting the audio signal according to the compensation value.

In an embodiment of the present invention, obtaining the frequency range comprises: filtering the audio signals to obtain a first audio signal with respect to the upper limit frequency and a second audio signal with respect to the lower limit frequency; and filtering the detected signal to obtain a first detected signal with respect to the upper limit frequency and a second detected signal with respect to the lower limit frequency.

In an embodiment of the present invention, calculating a first sound pressure difference corresponding to the upper limit frequency and the lower limit frequency of the audio signal comprises: according to the first audio signal and the second audio signal, obtaining a first sound pressure value corresponding to the upper limit frequency and a second sound pressure value corresponding to the lower limit frequency; and performing a subtraction operation on the first sound pressure value and the second sound pressure value to generate the first sound pressure difference.

In an embodiment of the present invention, calculating the second sound pressure difference corresponding to the upper limit frequency and the lower limit frequency of the detected signal comprises: according to the first detected signal and the second detected signal, obtaining a first detected sound pressure value corresponding to the upper limit frequency and a second detected sound pressure value corresponding to the lower limit frequency; and performing a subtraction operation on the first detected sound pressure value and the second detected sound pressure value to generate the second sound pressure difference.

In an embodiment of the present invention, generating the compensation value according to the first sound pressure difference and the second sound pressure difference comprises: performing a subtraction operation on the first sound pressure difference and the second sound pressure difference to generate a transient sound pressure value; performing an addition operation on the transient sound pressure value and a previous sound pressure value to generate a current sound pressure value; and generating the compensation value according to the current sound pressure value.

In an embodiment of the present invention, generating the compensation value according to the first sound pressure difference and the second sound pressure difference comprises: performing a subtraction operation on the first sound pressure difference and the second sound pressure difference to generate a transient sound pressure value; performing an addition operation on the transient sound pressure value and a previous sound pressure value to generate a current sound pressure value; receiving an external operation signal and generating a dynamic target sound pressure value according to the external operation signal; adjusting the current sound pressure value according to the dynamic target sound pressure value; and generating the compensation value according to the current sound pressure value.

In an embodiment of the present invention, the audio signal processing method further comprises: smoothing the first sound pressure difference and the second sound pressure difference.

According to the foregoing object, the present invention provides an audio signal processing apparatus comprising a loudspeaker, a microphone, and a processor. The loudspeaker is configured to play an audio signal. The microphone is configured to generate a detected signal. The processor is connected to the loudspeaker and the microphone, and the processor performs the following steps: obtaining a frequency range, wherein the frequency range includes an upper limit frequency and a lower limit frequency; calculating a first sound pressure difference between the audio signal filtered at the upper limit frequency and the audio signal filtered at the lower limit frequency; calculating a second sound pressure difference between the detected signal filtered at the upper limit frequency and the detected signal filtered at the lower limit frequency; generating a compensation value according to the first sound pressure difference and the second sound pressure difference; and adjusting the audio signal according to the compensation value.

In an embodiment of the present invention, the processor includes a high pass filter and a low pass filter, and obtaining the frequency range by the processor comprises: filtering the audio signal by the high pass filter and the low pass filter to obtain a first audio signal with respect to the upper limit frequency and a second audio signal with respect to the lower limit frequency, wherein the high pass filter and the low pass filter respectively filter the detected signal according to a reference frequency to obtain a first detected signal with respect to the upper limit frequency and a second detected signal with respect to the lower limit frequency.

In an embodiment of the present invention, calculating a first sound pressure difference between the audio signal filtered at the upper limit frequency and the audio signal filtered at the lower limit frequency by the processor comprises: the processor obtaining, according to the first audio signal and the second audio signal, a first sound pressure value corresponding to the upper limit frequency and a second sound pressure value corresponding to the lower limit frequency; and the processor performing a subtraction operation on the first sound pressure value and the second sound pressure value to generate the first sound pressure difference.

In an embodiment of the present invention, the processor calculating a second sound pressure difference between the detected signal filtered at the upper limit frequency and the detected signal filtered at the lower limit frequency comprises: the processor obtaining, according to the first detected signal and the second detected signal, a first detected sound pressure value corresponding to the upper limit frequency and a second detected sound pressure value corresponding to the lower limit frequency; and the processor performing a subtraction operation on the first detected sound pressure value and the second detected sound pressure value to generate the second sound pressure difference.

In an embodiment of the present invention, the processor comprises a memory and a low shelf filter, the memory stores a previous sound pressure value, and generating the compensation value according to the first sound pressure difference and the second sound pressure difference by the processor comprises: the processor performing a subtraction operation on the first sound pressure difference and the second sound pressure difference to generate a transient sound pressure value; the processor performing an addition operation on the transient sound pressure value and the previous sound pressure value to generate a current sound pressure value; and the low shelf filter generating the compensation value according to the current sound pressure value.

In an embodiment of the present invention, the processor comprises a memory and a low shelf filter, the memory stores a previous sound pressure value, and generating the compensation value according to the first sound pressure difference and the second sound pressure difference by the processor comprises: the processor performing a subtraction operation on the first sound pressure difference and the second sound pressure difference to generate a transient sound pressure value; the processor performing an addition operation on the transient sound pressure value and the previous sound pressure value to generate a current sound pressure value; the processor receiving an external operation signal and generating a dynamic target sound pressure value according to the external operation signal; the processor adjusting the current sound pressure value according to the dynamic target sound pressure value; and the low shelf filter generating a compensation value according to the adjusted current sound pressure value.

In an embodiment of the present invention, the processor further performs a smoothing process on the first sound pressure difference and the second sound pressure difference.

In summary, in the audio signal processing method and the audio signal processing apparatus of the present invention, based on the first sound pressure of the audio signal corresponding to the loudspeaker and the second sound pressure difference of the detected signal corresponding to the microphone, the compensation value is generated to compensate the audio signal to prevent sound attenuation and gain.

The above description is only an overview of the technical solution of the present invention. To understand the technical means of the present invention more clearly and for implementation in accordance with the contents of the description, the present invention is described in detail below with embodiments of the present invention and with the drawings.

### BRIEF DESCRIPTION OF DRAWINGS

FIG. 1 is a block diagram of an audio signal processing apparatus according to an embodiment of the present invention.

FIG. 2 is a block diagram of a processor according to an embodiment of the present invention.

FIG. 3 is a flowchart of an audio signal processing method according to an embodiment of the present invention.

FIG. 4 is a flowchart for calculating a first sound pressure difference in the audio signal processing method according to an embodiment of the present invention.

FIG. 5 is a flowchart for calculating a second sound pressure difference in the audio signal processing method according to an embodiment of the present invention.

FIG. 6A is a flowchart for generating a compensation value in the audio signal processing method according to an embodiment of the present invention.

FIG. 6B is a flowchart for generating the compensation value in the audio signal processing method according to another implementation of the present invention.

FIG. 7 is a flowchart of the audio signal processing method according to another embodiment of the present invention.

### DETAILED DESCRIPTION OF THE INVENTION

The implementation of the present invention is described below by specific embodiments, and persons having ordinary skill in the art can easily understand the advantages and effects of the present invention from the contents disclosed in this detailed description.

It should be noted that, without conflict, the embodiments in the present invention and the features in the embodiments may be combined with each other. The present invention is described in detail below with reference to the drawings and in conjunction with embodiments. In order to enable persons having ordinary skill in the art to better understand the present invention, the technical scheme in the embodiments of the present invention will be clearly and completely described below in conjunction with the drawings in the embodiments of the present invention, and it is obvious that the described embodiments are only illustrations of a part of the present invention, not all embodiments. According to the embodiments of the present invention, all other embodiments obtained by a person having ordinary skill in the art without creative work shall fall within the scope of protection of the present invention.

It should be noted that the terms “first”, “second”, etc. in the description and claims of the present invention and in the above-mentioned drawings are used to distinguish similar objects and are not intended to describe a specific order or sequence. In addition, the terms “including” and “having” and any variation thereof are intended to encompass non-exclusive inclusions, e.g., a process, a method, a system, a product or an apparatus containing a series of steps or elements, and are not intended to limit those steps or elements that are clearly listed, which may include other steps or elements that are not clearly listed or are inherent to those processes, methods, products or equipment.

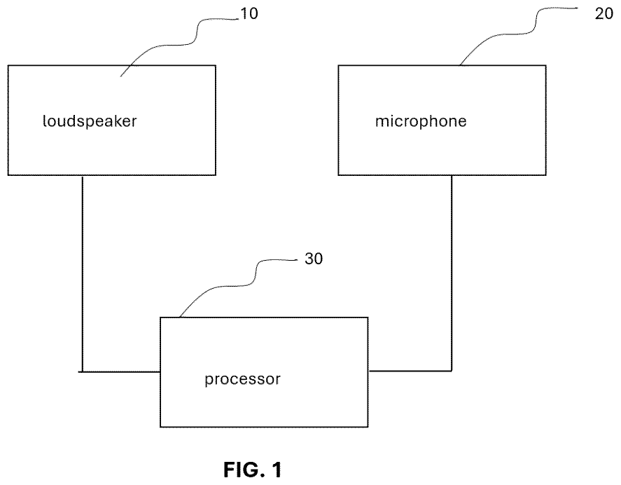

FIG. 1 is a block diagram of an audio signal processing apparatus according to an embodiment of the present invention. As shown in FIG. 1, the audio signal processing apparatus includes a loudspeaker 10, a microphone 20, and a processor 30. The audio signal processing apparatus can be, but is not limited to, a headset or a wireless earbud. The loudspeaker 10 is configured to play an audio signal. The microphone 20 is configured to generate a detected signal. The processor 30 is connected to the loudspeaker 10 and the microphone 20 to receive the audio signal and the detected signal. The digital signal processing and compensation value generation performed by the processor 30 on the audio signal and the detected signal will be described in the section of the audio signal processing method.

Specifically, the audio signal is played by the loudspeaker 10 to generate sound (such as a song or sound of a musical instrument), and the microphone 20 is adjacent to the loudspeaker 10 and generates a detected signal according to the sound. The processor 30 may be, but is not limited to, a central processing unit, a graphics processing unit, or other types of processors, the foregoing being merely examples and not limiting the scope listed in this application.

In addition, the audio signal processing apparatus is wirelessly connected to an external electronic device to receive an external operation signal. For example, the external electronic device is a mobile phone or a tablet computer. The processor 30 adjusts the current sound pressure value according to the external operation signal. The steps of the processor 30 adjusting the current sound pressure value according to the external operation signal will be described in the section of the audio signal processing method.

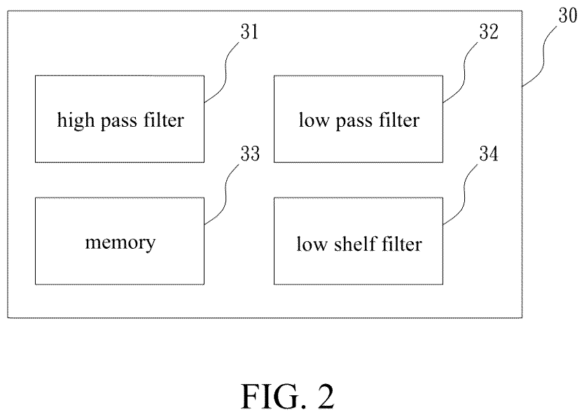

FIG. 2 is a block diagram of a processor according to an embodiment of the present invention. As shown in FIG. 2, the processor 30 includes a high pass filter 31, a low pass filter 32, a memory 33, and a low shelf filter 34. The high pass filter 31 filters the low-frequency part of the audio signal and the detected signal and allows the high-frequency part of the audio signal and the detected signal to pass through. The low pass filter 32 filters the high-frequency part of the audio signal and the detected signal and allows the audio signal and the detected signal to pass through. The memory 33 stores previous sound pressure values. The low shelf filter 34 compensates for the frequency response of the low-frequency part of the audio signal.

In another embodiment, the processor 30 includes a memory 33 and a peaking filter. The memory 33 stores digital transfer functions correspond to the high pass filter 31 and the low pass filter 32. The processor 30 obtains the digital transfer functions corresponding to the high pass filter 31 and the low pass filter 32 from the memory 33 and adopts the digital transfer functions corresponding to the high pass filter 31 and the low pass filter 32 to perform signal filtering on the audio signal and the detected signal so as to equate the functions of the high pass filter 31 and the low pass filter 32. The peaking filter compensates the frequency response of the low-frequency part of the audio signal.

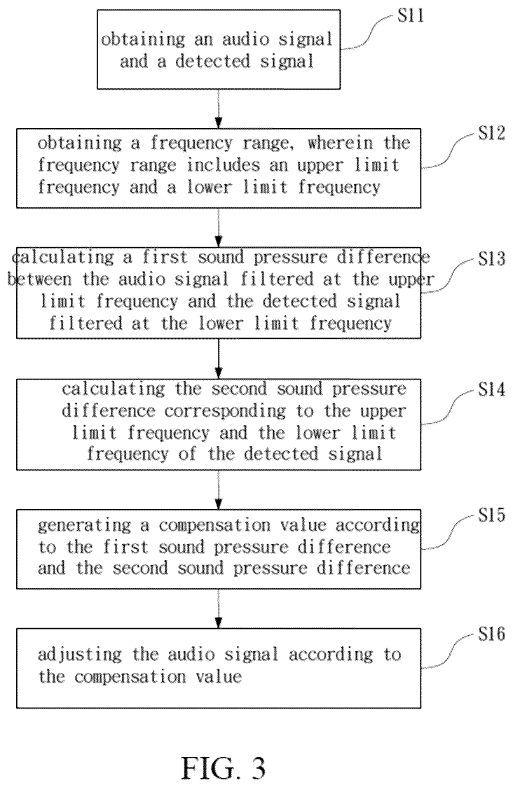

FIG. 3 is a flowchart of an audio signal processing method according to an embodiment of the present invention. As shown in FIG. 3, the audio signal processing method includes steps S11 to S16. The audio signal processing method shown in FIG. 3 may be adapted to the audio signal processing apparatuses shown in FIG. 1 and FIG. 2 but is not limited thereto. The following example describes steps S11 to S16 by employing the operation of the audio signal processing apparatus shown in FIG. 1 as an illustration.

Step S11: obtaining an audio signal and a detected signal. As mentioned above, the processor 30 is configured to obtain the audio signal and the detected signal from the loudspeaker 10 and the microphone 20.

Step S12: obtaining a frequency range, wherein the frequency range includes an upper limit frequency and a lower limit frequency.

In one embodiment, the high pass filter 31 filters the audio signal according to a reference frequency, filters the low-frequency part of the audio signal that is lower than the reference frequency, and retains the high-frequency part of the audio signal that is higher than the reference frequency as a first audio signal. The low pass filter 32 filters the audio signal according to the reference frequency, filters out the high-frequency part of the audio signal that is higher than the reference frequency, and retains the low-frequency part of the audio signal that is lower than the reference frequency as a second audio signal. In other words, the first audio signal is a high-frequency signal, and the second audio signal is a low-frequency signal. The processor 30 obtains the upper limit frequency and the lower limit frequency according to the first audio signal and the second audio signal.

The high pass filter 31 filters the detected signal according to the reference frequency, filters the low-frequency part of the detected signal that is lower than the reference frequency, and retains the high-frequency part of the detected signal that is higher than the reference frequency as a first detected signal. The low pass filter 32 filters the detected signal according to the reference frequency, filters out the high-frequency part of the detected signal that is higher than the reference frequency, and retains the low-frequency part of the detected signal that is lower than the reference frequency as a second detected signal. In other words, the first detected signal is a high-frequency signal, and the second detected signal is a low-frequency signal. The processor 30 obtains the upper limit frequency and the lower limit frequency according to the first detected signal and the second detected signal.

In another embodiment, the processor 30 obtains the digital transfer functions corresponding to the high pass filter 31 and the low pass filter 32 from the memory 33 and adopts the digital transfer functions corresponding to the high pass filter 31 and the low pass filter 32 to perform signal filtering on the audio signal and the detected signal to obtain a first audio signal, a second audio signal, a first detected signal and a second detected signal.

Step S13: calculating a first sound pressure difference between the audio signal filtered at the upper limit frequency and the audio signal filtered at the lower limit frequency. Specifically, the processor 30 first obtains a first sound pressure value of the audio signal at an upper limit frequency and a second sound pressure value of the audio signal at a lower limit frequency and performs a subtraction operation on the first sound pressure value and the second sound pressure value to generate the first sound pressure difference.

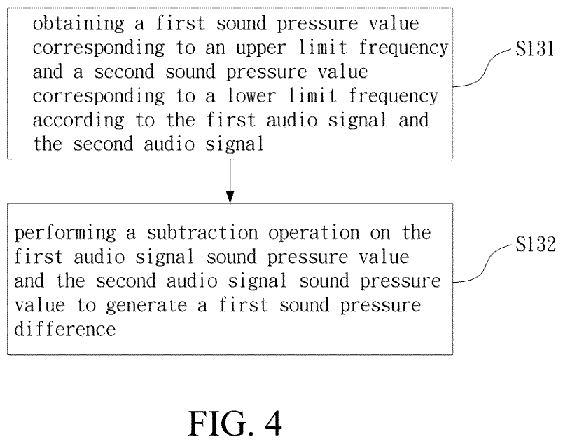

FIG. 4 is a flowchart for calculating a first sound pressure difference in the audio signal processing method according to an embodiment of the present invention. As shown in FIG. 4, the step of calculating the first sound pressure difference corresponding to the upper limit frequency and the lower limit frequency of the audio signal includes step S131 to step S132. The following example describes step S131 to step S132 by employing the operation of the audio signal processing apparatus shown in FIG. 1 and FIG. 2 as an illustration.

, Step S131: according to the first audio signal and the second audio signal, obtaining a first sound pressure value corresponding to the upper limit frequency and a second sound pressure value corresponding to the lower limit frequency. Specifically, according to the upper limit frequency, the processor 30 obtains a first audio sound pressure value corresponding to the upper limit frequency from the first audio signal, and according to the lower limit frequency, obtains a second sound pressure value corresponding to the lower limit frequency from the second audio signal.

Step S132: performing a subtraction operation on the first sound pressure value and the second sound pressure value to generate the first sound pressure difference. Specifically, the processor 30 subtracts the first audio signal sound pressure value from the second audio signal sound pressure value to generate a first sound pressure difference.

Step S14: calculating a second sound pressure difference between the detected signal filtered at the upper limit frequency and the detected signal filtered at the lower limit frequency. Specifically, the processor 30 first obtains a first detected sound pressure value of the detected signal filtered at the upper limit frequency and a second detected sound pressure value of the audio signal filtered at the lower limit frequency and performs a subtraction operation on the first detected sound pressure value and the second detected sound pressure value to generate the second sound pressure difference.

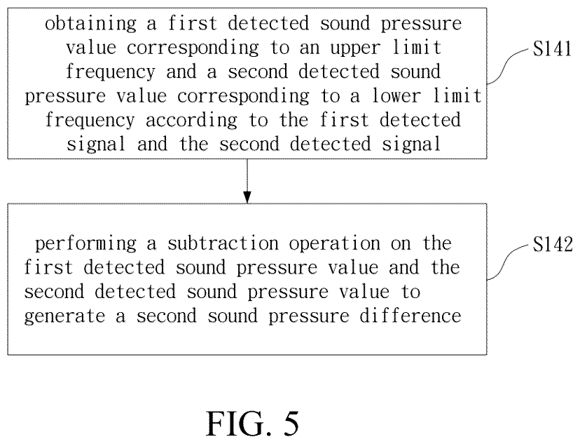

FIG. 5 is a flowchart for calculating a second sound pressure difference in the audio signal processing method according to an embodiment of the present invention. As shown in FIG. 5, the step of calculating the second sound pressure difference corresponding to the upper limit frequency and the lower limit frequency of the detected signal includes step S141 to step S143. The following example describes steps S141 to S143 by employing the operation of the audio signal processing apparatus shown in FIG. 1 and FIG. 2 as an illustration.

Step S141: according to the first detected signal and the second detected signal, obtaining a first detected sound pressure value corresponding to the upper limit frequency and a second detected sound pressure value corresponding to the lower limit frequency. Specifically, according to the upper limit frequency, the processor 30 obtains a first detected sound pressure value corresponding to the upper limit frequency from the first detected signal, and according to the lower limit frequency, obtains the second detected sound pressure value corresponding to the lower limit frequency from the second detected signal.

Step S142: performing a subtraction operation on the first detected sound pressure value and the second detected sound pressure value to generate the second sound pressure difference. Specifically, the processor 30 subtracts the first detected sound pressure value from the second detected sound pressure value to generate a second sound pressure difference.

Step S13 and step S14 are respectively for calculating the sound pressure difference between the audio signal and the detected signal filtered at the upper limit frequency and the lower limit frequency. The processor 30 can execute step 13 and step S14 simultaneously to synchronously generate the first sound pressure difference and the second sound pressure difference. Alternatively, the processor 30 may respectively execute step S13 and step S14 to generate the first sound pressure difference and the second sound pressure difference.

Step S15: generating a compensation value according to the first sound pressure difference and the second sound pressure difference.

In one implementation, the processor 30 performs calculations on the first sound pressure difference and the second sound pressure difference to generate a current sound pressure value and generates a compensation value according to the current sound pressure value.

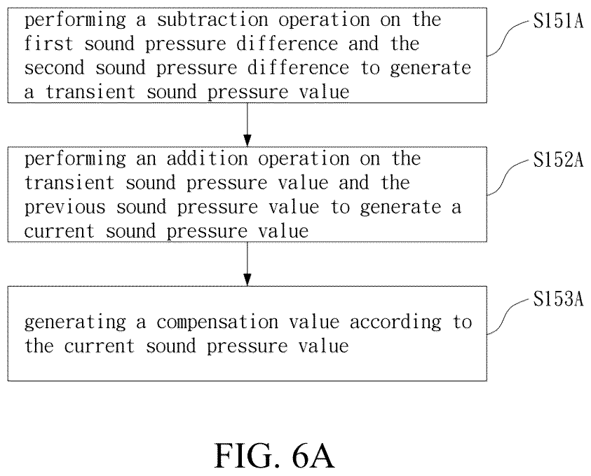

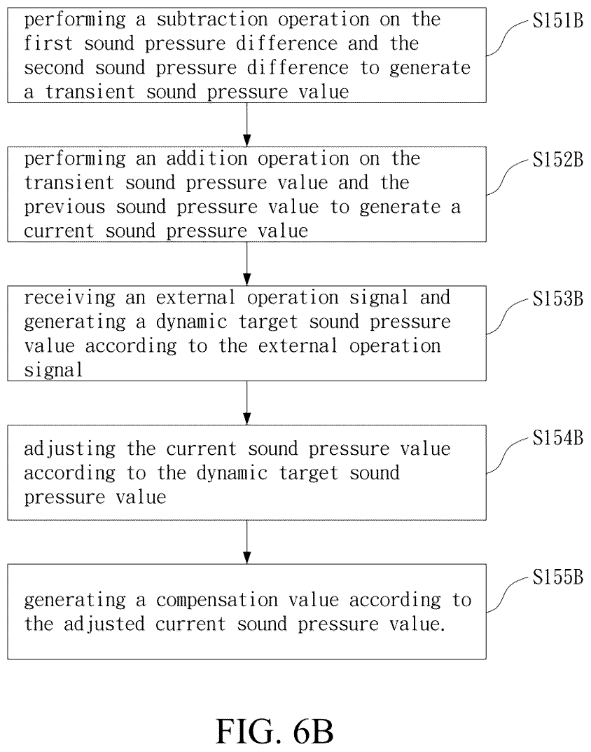

FIG. 6A is a flowchart for generating a compensation value in the audio signal processing method according to an embodiment of the present invention. As shown in FIG. 6A, the step of generating a compensation value according to the first sound pressure difference and the second sound pressure difference includes steps S151A to S153A. The following example describes steps S151A to S153A by employing the operation of the audio signal processing apparatus shown in FIG. 1 and FIG. 2 as an illustration.

Step S151A: performing a subtraction operation on the first sound pressure difference and the second sound pressure difference to generate a transient sound pressure value. Specifically, the processor 30 subtracts the first sound pressure difference from the second sound pressure difference to generate a transient sound pressure value.

Step S152A: performing an addition operation on the transient sound pressure value and a previous sound pressure value to generate a current sound pressure value. Specifically, the processor 30 first obtains the previous sound pressure value from the memory 33 and adds the previous sound pressure value and the transient sound pressure value to generate the current sound pressure value. At this time, the processor 30 transmits the current sound pressure value to the memory 33 for storage, and the current sound pressure value stored in the memory 33 is used as the previous sound pressure value.

The processor 30 executes steps S13, S14, S151A and S152A for the previous audio signal and the previous detected signal to generate the current sound pressure value and transmits the corresponding previous audio signal and the previous detected signal to the memory 33 for storage, and the current sound pressure value corresponding to the previous audio signal and the previous detected signal is regarded as the previous sound pressure value.

Step S153A: generating the compensation value according to the current sound pressure value. Specifically, the processor 30 transmits the current sound pressure value to the low shelf filter 34, and the low shelf filter 34 generates a compensation value according to the current sound pressure value. For example, the current sound pressure value is 5 dB, and the compensation value generated by the low shelf filter 34 is −5 dB.

In another embodiment, the processor 30 performs calculations on the first sound pressure difference and the second sound pressure difference to generate a current sound pressure value and receives an operation signal from an external electronic device to generate a dynamic target sound according to the operation signal. Then the processor 30 adjusts the current sound pressure value according to the dynamic target sound pressure value and generates a compensation value according to the adjusted current sound pressure value.

FIG. 6B is a flowchart for generating the compensation value in the audio signal processing method according to another implementation of the present invention. As shown in FIG. 6B, the step of generating a compensation value according to the first sound pressure difference and the second sound pressure difference includes steps S151B to S155B. Steps S151B and S152B are the same as steps S151A and S152A in FIG. 6A and are not described again herein. The following example illustrates steps S153B to S155B by employing the operation of the audio signal processing apparatus shown in FIG. 1 and FIG. 2 as an illustration.

Step S153B: receiving an external operation signal and generating a dynamic target sound pressure value according to the external operation signal.

Specifically, the user uses an external electronic device to generate an external operation signal, and the external electronic device transmits the external operation signal to the audio signal processing apparatus. Then, in response to the input of the external operation signal, the processor 30 generates a corresponding dynamic target sound pressure value according to the external operation signal. The external electronic device can generate a plurality of different operation signals, and the plurality of different operation signals correspond to a plurality of different dynamic target sound pressure values. In other words, the dynamic target sound pressure value changes with the change of the external operating signal.

Step S154B: adjusting the current sound pressure value according to the dynamic target sound pressure value. Specifically, the processor 30 changes the current sound pressure value according to the dynamic target sound pressure value. Furthermore, the processor 30 performs a subtraction operation on the current sound pressure value and the dynamic target sound pressure value. After the subtraction operation, the current sound pressure value is the adjusted current sound pressure value. The adjusted current sound pressure value changes with the dynamic target sound pressure value.

Step S155B: generating the compensation value according to the current sound pressure value. Specifically, the processor 30 transmits the adjusted current sound pressure value to the low shelf filter 34, and the low shelf filter 34 generates a compensation value according to the adjusted current sound pressure value. For example, the current sound pressure value after adjustment is −3 dB, and the compensation value generated by the low shelf filter 34 is +3 dB.

Through steps S151B to S155B, the current sound pressure value is adjusted according to the user's preference. Since the adjustment of the current sound pressure value will change the compensation value, the change of the compensation value affects the sound effect of the audio signal in the low-frequency part. For example, the sound effect of the low-frequency part in the audio signal is enhanced or reduced through steps S151B to S155B.

Step S16: adjusting the audio signal according to the compensation value. Specifically, the low shelf filter 34 adjusts the sound pressure value of the audio signal according to the compensation value to compensate for the frequency response of the audio signal in the low-frequency part.

When the loudspeaker 10 actually plays a piece of music, the piece of music includes multiple sections of audio signals. When the loudspeaker 10 plays each section of audio signal, the processor 30 performs steps S13, S14, S151 and S152 on each section of audio signal and each section of the detected signal to obtain the corresponding current sound pressure value. The multiple sections of current sound pressure values corresponding to the multiple audio signals are all different. The low shelf filter 34 generates multiple compensation values according to multiple different current sound pressure values, and the processor 30 compensates multiple audio signals according to multiple compensation values.

For example, a piece of music includes a first audio signal section, a second audio signal section, and a third audio signal section. The first audio signal section corresponds to the first section of the detected signal, the second audio signal section corresponds to the second section of the detected signal, and the third audio signal section corresponds to the third section of the detected signal. When the loudspeaker 10 plays the first audio signal section, the processor 30 performs steps S13, S14, S151 and S152 on the first audio signal section and the first section of the detected signal to generate a first current sound pressure value and transmits the first current sound pressure value to the memory 33 and the low shelf filter 34. The low shelf filter 34 also generates a first compensation value according to the first current sound pressure value. The low shelf filter 34 uses the first compensation value to adjust the first audio signal section.

When the loudspeaker 10 plays the second audio signal section, the processor 30 performs steps S13, S14 and S151 on the second audio signal section and the second detected signal to generate a second transient sound pressure value. The first current sound pressure value is regarded as the first previous sound pressure value, and the processor 30 performs step S152 on the second transient sound pressure value and the first previous sound pressure value to generate a second current sound pressure value and transmits the second current sound pressure value to the memory 33 and the low shelf filter 34. The low shelf filter 34 generates a second compensation value according to the second current sound pressure value. The low shelf filter 34 uses the second compensation value to compensate the second audio signal section. Therefore, when the second transient sound pressure value is zero, the first previous sound pressure value is equal to the second current sound pressure value, and the second compensation value generated by the low shelf filter 34 is the same as the first compensation value, thereby preventing the low shelf filter 34 from causing the compensation value to be zero.

When the loudspeaker 10 plays the third audio signal section, the processor 30 performs steps S13, S14 and S151 on the third audio signal section and the third detected signal to generate a third transient sound pressure value. The current sound pressure value is regarded as the second previous sound pressure value, and the processor 30 performs step S152 on the third transient sound pressure value and the second previous sound pressure value to generate a third current sound pressure value and transmits the third current sound pressure value to the memory 33 for storage. The processor 30 also generates a third compensation value according to the third current sound pressure value, and the low shelf filter 34 uses the third compensation value to compensate the third audio signal section. Therefore, when the third transient sound pressure value is zero, the second previous sound pressure value is equal to the third current sound pressure value, and the third compensation value generated by the low shelf filter 34 is the same as the second compensation value, thereby preventing the low shelf filter 34 from causing the compensation value to be zero.

In the audio signal processing method of this embodiment, different compensation values are generated according to the correction requirements of multiple different audio signals to compensate multiple different audio signals, thereby preventing the occurrence of sound attenuation and gain.

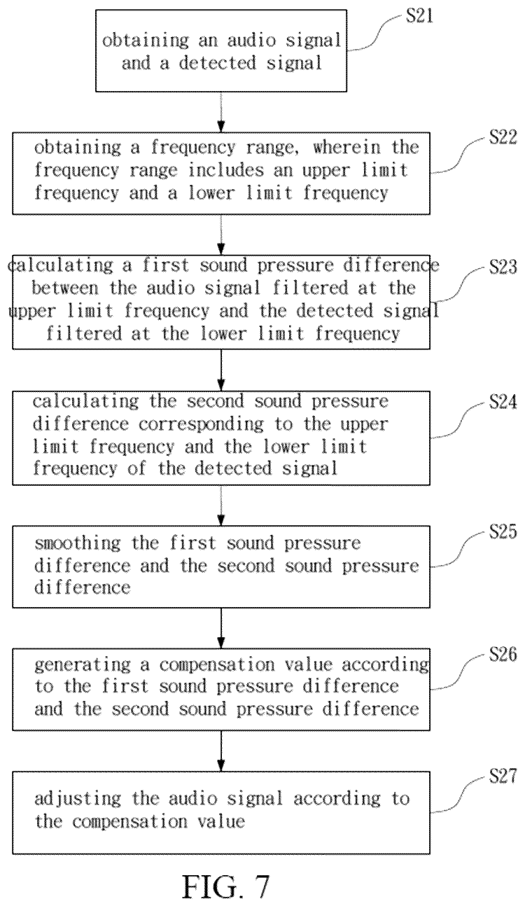

FIG. 7 is a flowchart of the audio signal processing method according to another embodiment of the present invention. As shown in FIG. 7, the audio signal processing method includes steps S21 to S27. Steps S21 to S24, step S26 and step S27 are the same as steps S11 to S16 shown in FIG. 3 and are not described again herein. The following example illustrates step S25 by employing the operation of the audio signal processing apparatus shown in FIG. 1 as an illustration.

Step S25: smoothing the first sound pressure difference and the second sound pressure difference. Specifically, the processor 30 performs a smoothing process on the first sound pressure difference and the second sound pressure difference. It should be noted that the upper limit frequency is a high frequency range based on the reference frequency and has a plurality of first frequency points, and the lower limit frequency is a low frequency range based on the reference frequency and has a plurality of second frequency points. Accordingly, the first sound pressure difference includes a plurality of first data points, the second sound pressure difference includes a plurality of second data points, the representative value of the first sound pressure difference is the average value of the plurality of first data points, and the representative value of the second sound pressure difference is the average value of the plurality of first data points. Therefore, through the smoothing process, abnormal data points among the plurality of first data points and the plurality of second data points are removed.

In summary, in the audio signal processing method and the audio signal processing apparatus of the present invention, based on the first sound pressure of the audio signal corresponding to the loudspeaker and the second sound pressure difference of the detected signal corresponding to the microphone, a compensation value is generated to compensate the audio signal to prevent sound attenuation and gain.

What is claimed is:

1. An audio signal processing method, comprising:
obtaining an audio signal and a detected signal;
obtaining a frequency range, wherein the frequency range includes an upper limit frequency and a lower limit frequency;
calculating a first sound pressure difference between the audio signal filtered at the upper limit frequency and the audio signal filtered at the lower limit frequency;
calculating a second sound pressure difference between the detected signal filtered at the upper limit frequency and the detected signal filtered at the lower limit frequency;
generating a compensation value according to the first sound pressure difference and the second sound pressure difference; and
adjusting the audio signal according to the compensation value.

2. The audio signal processing method as claimed in claim 1, wherein said obtaining the frequency range comprises:
filtering the audio signal to obtain a first audio signal with respect to the upper limit frequency and a second audio signal with respect to the lower limit frequency; and
filtering the detected signal to obtain a first detected signal with respect to the upper limit frequency and a second detected signal with respect to the lower limit frequency.

3. The audio signal processing method as claimed in claim 2, wherein said calculating a first sound pressure difference between the audio signal filtered at the upper limit frequency and the audio signal filtered at the lower limit frequency comprises:
according to the first audio signal and the second audio signal, obtaining a first sound pressure value corresponding to the upper limit frequency and a second sound pressure value corresponding to the lower limit frequency; and
performing a subtraction operation on the first sound pressure value and the second sound pressure value to generate the first sound pressure difference.

4. The audio signal processing method as claimed in claim 2, wherein said calculating the second sound pressure difference between the detected signal at the upper frequency and the detected signal at the lower frequency comprises:
according to the first detected signal and the second detected signal, obtaining a first detected sound pressure value corresponding to the upper limit frequency and a second detected sound pressure value corresponding to the lower limit frequency; and
performing a subtraction operation on the first detected sound pressure value and the second detected sound pressure value to generate the second sound pressure difference.

5. The audio signal processing method as claimed in claim 1, wherein said generating the compensation value according to the first sound pressure difference and the second sound pressure difference comprises:
performing a subtraction operation on the first sound pressure difference and the second sound pressure difference to generate a transient sound pressure value;
performing addition operation on the transient sound pressure value and a previous sound pressure value to generate a current sound pressure value; and
generating a compensation value according to the current sound pressure value.

6. The audio signal processing method as claimed in claim 1, wherein said generating the compensation value according to the first sound pressure difference and the second sound pressure difference comprises:
performing a subtraction operation on the first sound pressure difference and the second sound pressure difference to generate a transient sound pressure value;
performing an addition operation on the transient sound pressure value and a previous sound pressure value to generate a current sound pressure value;
receiving an external operation signal and generating a dynamic target sound pressure value according to the external operation signal;
adjusting the current sound pressure value according to the dynamic target sound pressure value; and
generating a compensation value according to the adjusted current sound pressure value.

7. The audio signal processing method as claimed in claim 1, further comprising smoothing the first sound pressure difference and the second sound pressure difference.

8. An audio signal processing apparatus, comprising:
a loudspeaker configured to play an audio signal;
a microphone configured to generate a detected signal; and
a processor connected to the loudspeaker and the microphone, wherein the processor is configured to perform:
obtaining a frequency range, wherein the frequency range includes an upper limit frequency and a lower limit frequency;
calculating a first sound pressure difference between the audio signal filtered at the upper limit frequency and the audio signal filtered at the lower limit frequency;
calculating a second sound pressure difference between the detected signal filtered at the upper limit frequency and the detected signal filtered at the lower limit frequency;
generating a compensation value according to the first sound pressure difference and the second sound pressure difference; and
adjusting the audio signal according to the compensation value.

9. The audio signal processing apparatus as claimed in claim 8, wherein the processor includes a high pass filter and a low pass filter, and
wherein said obtaining the frequency range by the processor comprises filtering the audio signal by the high pass filter and the low pass filter to obtain a first audio signal with respect to the upper limit frequency and a second audio signal with respect to the lower limit frequency, and
wherein the high pass filter and the low pass filter respectively filter the detected signal according to a reference frequency to obtain a first detected signal with respect to the upper limit frequency and a second detected signal with respect to the lower limit frequency.

10. The audio signal processing apparatus as claimed in claim 9, wherein said calculating the first sound pressure difference between the audio signal filtered at the upper limit frequency and the audio signal filtered at the lower limit frequency by the processor comprises:
the processor obtaining, according to the first audio signal and the second audio signal, a first sound pressure value corresponding to the upper limit frequency and a second sound pressure value corresponding to the lower limit frequency; and
the processor performing a subtraction operation on the first sound pressure value and the second sound pressure value to generate a first sound pressure difference.

11. The audio signal processing apparatus as claimed in claim 9, wherein the processor calculates a second sound pressure difference between the detected signal filtered at the upper limit frequency and the detected signal filtered at the lower limit frequency, comprising:
the processor obtaining, according to the first detected signal and the second detected signal, a first detected sound pressure value corresponding to the upper limit frequency and a second detected sound pressure value corresponding to the lower limit frequency; and
the processor performing a subtraction operation on the first detected sound pressure value and the second detected sound pressure value to generate the second sound pressure difference.

12. The audio signal processing apparatus as claimed in claim 8, wherein the processor comprises:
a memory configured to store a previous sound pressure value; and
a low shelf filter, and
wherein said generating the compensation value according to the first sound pressure difference and the second sound pressure difference by the processor comprises:
the processor performing a subtraction operation on the first sound pressure difference and the second sound pressure difference to generate a transient sound pressure value;
the processor performing an addition operation on the transient sound pressure value and a previous sound pressure value to generate a current sound pressure value; and
the low shelf filter generating a compensation value according to the current sound pressure value.

13. The audio signal processing apparatus as claimed in claim 8, wherein the processor comprises:
a memory configured to store a previous sound pressure value; and
a low shelf filter, and
wherein said generating the compensation value according to the first sound pressure difference and the second sound pressure difference by the processor comprises:
the processor performing a subtraction operation on the first sound pressure difference and the second sound pressure difference to generate a transient sound pressure value;
the processor performing an addition operation on the transient sound pressure value the previous sound pressure value to generate a current sound pressure value;
the processor receiving an external operation signal and generating a dynamic target sound pressure value according to the external operation signal;
the processor adjusting the current sound pressure value according to the dynamic target sound pressure value; and
the low shelf filter generating a compensation value according to the adjusted current sound pressure value.

14. The audio signal processing apparatus as claimed in claim 8, wherein the processor further performs a smoothing process on the first sound pressure difference and the second sound pressure difference.
